(19) United States
(12) Patent Application Publication
(10) Pub. No.: US 2017/0058129 A1
(43) Pub. Date: Mar. 2, 2017

(54) HARD-COATING LAYER, METHOD OF FABRICATING THE SAME AND DISPLAY DEVICE INCLUDING THE SAME

(71) Applicant: LG DISPLAY CO., LTD., Seoul (KR)

(72) Inventors: Jae-Hyun PARK, Seoul (KR); Wy-Yong KIM, Seoul (KR); Chang-Woo CHUN, Cheonan-si (KR)

(21) Appl. No.: 15/245,374

(22) Filed: Aug. 24, 2016

(30) Foreign Application Priority Data
Aug. 26, 2015 (KR) 10-2015-0120575

(51) Int. Cl. C09D 4/00; G06F 3/041

(52) U.S. Cl. CPC C09D 4/00; G06F 3/041; C08K 5/548

(57) ABSTRACT

Described herewith is a hard-coating layer comprising a binder; and a silicon compound dispersed in the binder and including a disulfide group conncecting adjacent siloxane groups, a method of manufacturing the hard-coating layer, and a display device included the same.

The present application claims the benefit of Korean Patent Application No. 10-2015-0120575 filed in Korea on Aug. 26, 2015, which is hereby incorporated by reference in its entirety.

### BACKGROUND

Technical Field

The present invention relates to a hard-coating layer having a self-healing characteristic (property), a method of fabricating the hard-coating layer and a display device including the hard-coating layer.

Discussion of the Related Art

As society has entered in earnest into the information age, various display devices for displaying images have been required. Flat panel display devices, such as LCD devices, plasma display panels (PDP), and organic light emitting diode (OLED) display devices, tend to have a thin profile, be lightweight, consume less power, and so on, relative to a cathode ray tube (CRT) device. Such devices have been widely researched and developed to replace the CRT display.

Recently, portable display devices, e.g., a mobile phone, are widely used. Thus, the requirement for lightweight devices having a thin profile has increased, such as a display device without a cover glass.

However, damage, e.g., scratches, by a touch operation can occur on a display surface of a display device having a touch unit, but lacking a cover glass.

To prevent damage to such display devices, a hard-coating layer is formed as an outmost layer of the display device. However, with long-time operation, damage to the display surface of the display device can still occur. Namely, damage in the initial operation stage is prevented by the hard-coating layer, but the display device can be damaged by stress accumulation when operated for a long time.

### SUMMARY

Exemplary embodiments of the present invention are directed to a hard-coating layer, a method of fabricating the hard-coating layer and a display device including the hard-coating layer that substantially obviates one or more of the problems due to limitations and disadvantages of the related art.

An exemplary embodiment is a hard-coating layer, comprising: a binder; and a silicon compound dispersed in the binder, wherein the silicon compound comprises a disulfide group, which connects adjacent siloxane groups.

Another exemplary embodiment is a hard-coating layer, wherein the siloxane group is a silsesquioxane derivative.

Another exemplary embodiment is a hard-coating layer, wherein the silicon compound is represented by following Formula 1, wherein SSQ is the silsesquioxane derivative, and R is an aromatic group or

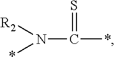

where R₂ is a C1-C20 alkyl; and Formula 1 is

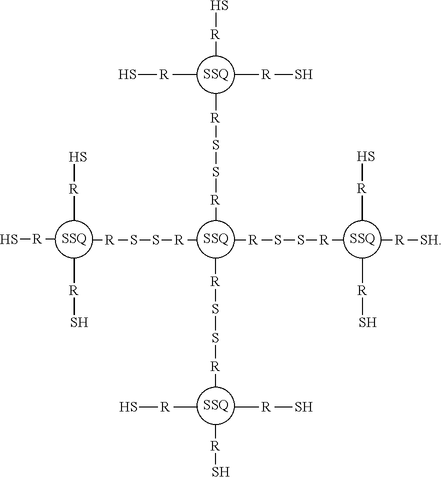

Another exemplary embodiment is a display device, comprising: a hard-coating layer including a binder and a silicon compound dispersed in the binder, wherein the silicon compound comprises a disulfide group connecting adjacent siloxane groups; and a display device on a side of the hard-coating layer.

Another exemplary embodiment is a display device, wherein the display panel includes a polarization plate, and the hard-coating layer is in contact with the polarization plate.

Another exemplary embodiment is a display device, further comprising: a touch panel positioned between the hard-coating layer and the display panel.

Another exemplary embodiment is a display device, wherein the hard-coating layer has a self-healing characteristic.

Another exemplary embodiment is method of fabricating a hard-coating layer, comprising: coating a mixture including a silicon compound, a photo-reactive compound, a photo-initiator and a solvent on a base, wherein the silicon compound includes a disulfide group connecting adjacent siloxane groups; and irradiating the coated mixture with UV radiation to form the hard-coating material layer.

Additional features and advantages of the invention will be set forth in the description which follows, and in part will be apparent from the description, or may be learned by practice of the invention. The objectives and other advantages of the invention will be realized and attained by the structure particularly pointed out in the written description, and the claims and drawings thereof.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the embodiments of the invention.

FIG. 1 is a schematic cross-sectional view of a display device according to the present invention.

FIGS. 2A and 2B are schematic cross-sectional views of a display panel.

FIG. 3 is a view illustrating a self-healing mechanism in a hard-coating layer according to the present invention.

FIGS. 4A to 4C show particle size distributions of a silicon compound.

FIG. 5 is a Raman spectrograph showing the presence of a disulfide group in a hard-coating layer.

FIG. 6 is a graph showing an anti-scratch characteristic of a hard-coating layer.

### DETAILED DESCRIPTION

Reference will now be made in detail to the exemplary embodiments, examples of which are illustrated in the accompanying drawings.

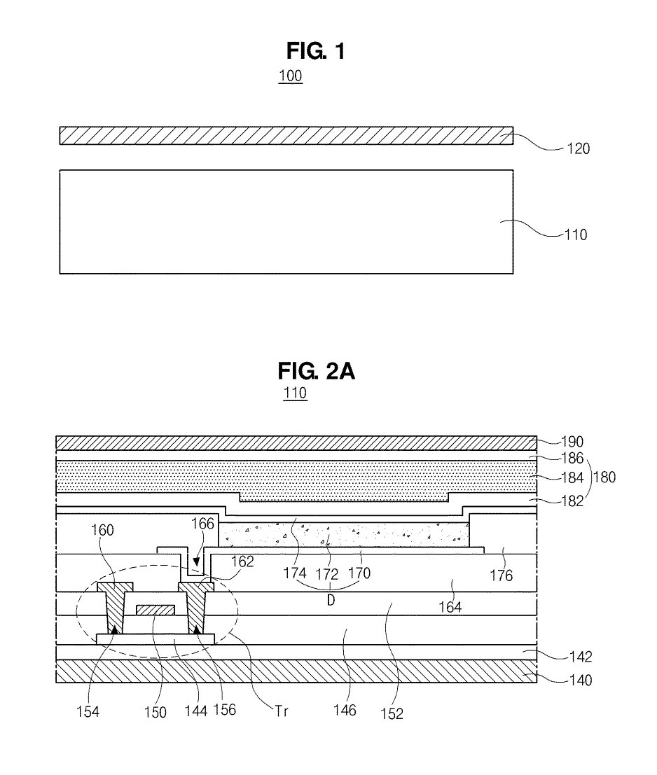

FIG. 1 is a schematic cross-sectional view of a display device according to the present invention.

Referring to FIG. 1, a display device 100 according to the present invention includes a display panel 110 and a hard-coating layer 120 on a side of the display panel 110. Namely, the hard-coating layer 120 faces a display surface of the display panel 110 and forms an outermost layer of the display device 100.

The hard-coating layer 120 includes a silicon compound (i.e., silicide). The silicon compound includes a disulfide group (—S—S—), which is related to the self-healing characteristic, and a siloxane group (—Si—O—Si—). Two siloxane groups are connected to either end of the disulfide group such that the disulfide group is protected. In other words, adjacent siloxane groups are connected or linked by the disulfide group.

When stress is applied to the display device 100 during the operation of the device, the disulfide group in the hard-coating layer 120 dissociates such that defects are generated in the hard-coating layer 120, and these defects grow such that surface damage occurs.

However, in the hard-coating layer 120 of the present invention, the disulfide group is re-generated following dissociation when irradiated with visible light, and thus, the defects are healed, preventing damage to the hard-coating layer 120. These defects may be directly healed with direct light irradiation.

In addition, since the dissociation and re-combination of the disulfide groups are repeated, the hard-coating layer 120 has a semipermanent self-healing characteristic. As a result, the durability of the hard-coating layer 120 and the display device 100 is improved.

Moreover, the siloxane group may be silsesquioxane derivatives such that the hard-coating layer 120 has a sufficient hardness (stiffness). Accordingly, the hard-coating layer 120 is suitable for forming an outermost layer of the display device 100.

Namely, the hard-coating layer 120 having an excellent hardness property and a self-healing characteristic is provided such that surface damage of the hard-coating layer 120 is prevented. Since the hard-coating layer 120 is used as the outermost layer of the display device 100, the display device 100 can have a thin profile and be made lightweight without a cover glass.

Although not shown, a touch panel may be positioned between the display panel 110 and the hard-coating layer 120.

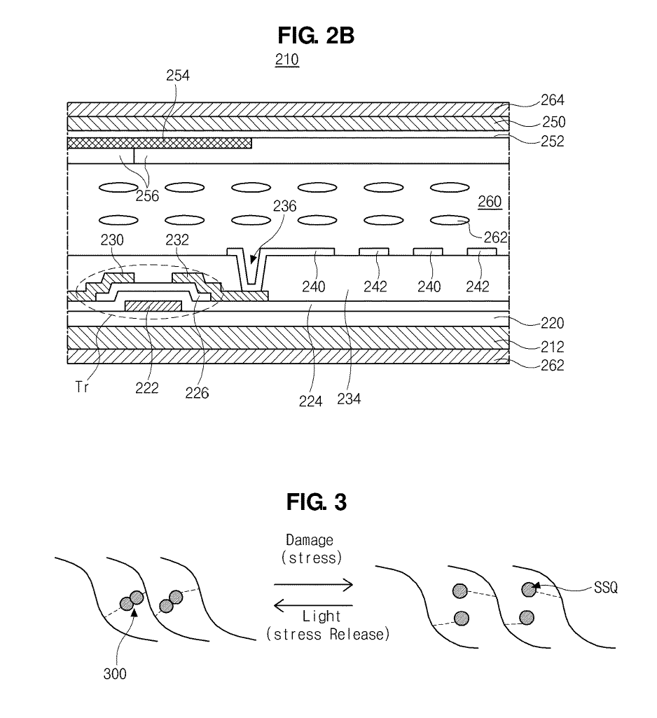

FIGS. 2A and 2B are schematic cross-sectional views of a display panel.

As shown in FIG. 2A, the display panel 110 may be an emitting diode panel.

Namely, the display panel 110 may include a substrate 140, a thin film transistor (TFT) Tr on or above the substrate 140, an emitting diode D disposed above the substrate 140 and connected to the TFT Tr and an encapsulation film 180 covering the emitting diode D.

The substrate 140 may be a glass substrate or a flexible substrate. The flexible substrate may be formed of a metal or a plastic. For example, the flexible substrate may be a polyimide substrate.

In a manufacturing process of elements, e.g., the TFT Tr, of the display panel 110, a carrier substrate (not shown) may be attached to a lower surface of the flexible substrate 22, elements such as the TFT may be formed on the flexible substrate, and the carrier substrate may be released to obtain the flexible display panel 110.

A buffer layer 142 is formed on the flexible substrate 140, and the TFT Tr is formed on the buffer layer 142. The buffer layer 142 may be formed of an inorganic insulating material such as silicon oxide or silicon nitride. The buffer layer 142 may be omitted.

A semiconductor layer 144 is formed on the buffer layer 142. The semiconductor layer 144 may include an oxide semiconductor material or polycrystalline silicon.

When the semiconductor layer 144 includes the oxide semiconductor material, a light-shielding pattern (not shown) may be formed under the semiconductor layer 144. The light to the semiconductor layer 144 is shielded or blocked by the light-shielding pattern such that thermal degradation of the semiconductor layer 144 can be prevented. On the other hand, when the semiconductor layer 144 includes polycrystalline silicon, impurities may be doped into both sides of the semiconductor layer 144.

A gate insulating layer 146 is formed on the semiconductor layer 144. The gate insulating layer 146 may be formed of an inorganic insulating material such as silicon oxide or silicon nitride.

A gate electrode 150, which is formed of a conductive material, e.g., metal, is formed on the gate insulating layer 146 to correspond to a center of the semiconductor layer 144.

In FIG. 2A, the gate insulating layer 146 is formed on the entire surface of the substrate 140. Alternatively, the gate insulating layer 146 may be patterned to have the same shape as the gate electrode 150.

An interlayer insulating layer 152, which is formed of an insulating material, is formed on an entire surface of the substrate 140 including the gate electrode 150. The interlayer insulating layer 152 may be formed of an inorganic insulating material, e.g., silicon oxide or silicon nitride, or an organic insulating material, e.g., benzocyclobutene or photo-acryl.

The interlayer insulating layer 152 includes first and second contact holes 154 and 156 exposing the semiconductor layer 144 through the contact holes 154 and 156. The first and second contact holes 154 and 156 are positioned at both sides of the gate electrode 150 to be spaced apart from the gate electrode 150.

In FIG. 2A, the first and second contact holes 154 and 156 extend into the gate insulating layer 146. Alternatively, when the gate insulating layer 146 is patterned to have the same shape as the gate electrode 150, there may be no first and second contact holes 154 and 156 in the gate insulating layer 146.

A source electrode 160 and a drain electrode 162, which are formed of a conductive material, e.g., metal, are formed on the interlayer insulating layer 152. The source electrode 160 and the drain electrode 162 are spaced apart from each other with respect to the gate electrode 150 and contact the semiconductor layer 144 through the first and second contact holes 154 and 156, respectively.

The semiconductor layer 144, the gate electrode 150, the source electrode 160 and the drain electrode 162 constitute the TFT Tr, and the TFT Tr serves as a driving element.

In FIG. 2A, the gate electrode 150, the source electrode 160 and the drain electrode 162 are positioned over the semiconductor layer 144. Namely, the TFT Tr has a coplanar structure.

Alternatively, in the TFT Tr, the gate electrode may be positioned under the semiconductor layer, and the source and drain electrodes may be positioned over the semiconductor layer such that the TFT Tr may have an inverted staggered structure. In this instance, the semiconductor layer may include amorphous silicon.

Although not shown, a gate line and a data line are disposed on or above the substrate 140 and cross each other to define a pixel region. In addition, a switching element, which is electrically connected to the gate line and the data line, may be disposed on the substrate 140. The switching element is electrically connected to the TFT Tr as the driving element.

In addition, a power line, which is parallel to and spaced apart from the gate line or the data line, may be formed on or above the substrate 140. Moreover, a storage capacitor for maintaining a voltage of the gate electrode 150 of the TFT Tr, may be further formed on the substrate 140.

A passivation layer 164, which includes a drain contact hole 166 exposing the drain electrode 162 of the TFT Tr, is formed to cover the TFT Tr.

A first electrode 170, which is connected to the drain electrode 162 of the TFT Tr through the drain contact hole 166, is separately formed in each pixel region. The first electrode 170 may be an anode and may be formed of a conductive material having a relatively high work function. For example, the first electrode 170 may be formed of a transparent conductive material such as indium-tin-oxide (no) or indium-zinc-oxide (IZO).

When the display panel 110 is operated as a top-emission type, a reflection electrode or a reflection layer may be formed under the first electrode 170. For example, the reflection electrode or the reflection layer may be formed of aluminum-paladium-copper (APC) alloy.

A bank layer 176, which covers edges of the first electrode 170, is formed on the passivation layer 164. A center of the first electrode 170 in the pixel region is exposed through an opening of the bank layer 176.

An organic emitting layer 172 is formed on the first electrode 170. The organic emitting layer 172 may have a single-layered structure of an emitting material layer formed of an emitting material. Alternatively, to improve emitting efficiency, the organic emitting layer 172 may have a multi-layered structure including a hole injection layer, a hole transporting layer, the emitting material layer, an electron transporting layer and an electron injection layer sequentially stacked on the first electrode 170.

A second electrode 174 is formed above the substrate 140 including the organic emitting layer 172. The second electrode 174 is positioned on an entire surface of the display area. The second electrode 174 may be a cathode and may be formed of a conductive material having a relatively low work function. For example, the second electrode 174 may be formed of aluminum (Al), magnesium (Mg) or Al—Mg alloy.

The first electrode 170, the organic emitting layer 172 and the second electrode 174 constitute the emitting diode D.

An encapsulation film 180 is formed on the emitting diode D to prevent penetration of moisture into the emitting diode D. The encapsulation film 180 may have a triple-layered structure of a first inorganic layer 182, an organic layer 184 and a second inorganic layer 186. However, it is not limited thereto.

A polarization plate 190 may be disposed on the encapsulation film 180 to reduce ambient light reflection. The polarization plate may be a circular polarization film. Without a problem of the contrast ratio decrease by the ambient light, the polarization plate may be omitted.

On the other hand, as shown in FIG. 3B, a liquid crystal panel 210 may be used for the display panel 110.

The liquid crystal panel 210 includes first and second substrates 212 and 250, which face each other, and a liquid crystal layer 260, which includes liquid crystal molecules 262, therebetween.

A first buffer layer 220 is formed on the first substrate 212, and a TFT Tr is formed on the first buffer layer 220. The first buffer layer 220 may be omitted.

A gate electrode 222 is formed on the first buffer layer 220, and a gate insulating layer 224 is formed on the gate electrode 222. In addition, a gate line (not shown), which is connected to the gate electrode 222, is formed on the first buffer layer 220.

A semiconductor layer 226, which corresponds to the gate electrode 222, is formed on the gate insulating layer 224. The semiconductor layer 226 may include an oxide semiconductor material. Alternatively, the semiconductor layer 226 may include an active layer of intrinsic amorphous silicon and an ohmic contact layer of impurity-doped amorphous silicon.

A source electrode 230 and a drain electrode 232, which are spaced apart from each other, are formed on the semiconductor layer 226. In addition, a data line (not shown), which is connected to the source electrode 230 and crosses the gate line to define a pixel region, is formed.

The gate electrode 222, the semiconductor layer 226, the source electrode 230 and the drain electrode 232 constitute the TFT Tr.

A passivation layer 234, which includes a drain contact hole 236 exposing the drain electrode 232, is formed on the TFT Tr.

A pixel electrode 240, which is connected to the drain electrode 232 through the drain contact hole 236, and a common electrode 242, which is alternately arranged with the pixel electrode 240, are formed on the passivation layer 234.

A second buffer layer 252 is formed on the second substrate 250, and a black matrix 254, which shields a non-display region such as the TFT Tr, the gate line and the data line, is formed on the second buffer layer 252. In addition, a color filter layer 256, which corresponds to the pixel region, is formed on the second buffer layer 252. The second buffer layer 252 and the black matrix 254 may be omitted.

The first and second substrates 212 and 250 are attached with the liquid crystal layer 260 therebetween. The liquid crystal molecules 262 of the liquid crystal layer 260 are driven by an electric field between the pixel and common electrode 240 and 242.

First and second polarization plates 262 and 264, which have perpendicular transmission axes, may be attached to an outer side of each of the first and second substrates 212 and 250.

Although not shown, first and second alignment layers may be formed over the first and second substrates 212 and 250 to be adjacent to the liquid crystal layer 260. In addition, a flexible backlight unit may be disposed under the first substrate 212 to provide light.

The hard-coating layer 120 (of FIG. 1) may be coated or attached to an outer side of the second polarization plate 264. The hard-coating layer 120 includes a binder and the silicon compound dispersed in the binder. The silicon compound includes the disulfide group for self-healing and siloxane groups being connected or linked to both sides of the disulfide group to protect the disulfide group.

To increase the hardness of the hard-coating layer 120, the siloxane group may be silsesquioxane derivatives. Namely, the silicon compound includes the silsesquioxane (SSQ) derivative for the hardness and the disulfide group for the self-healing characteristic and may be represented by following Formula 1. In addition, the silsesquioxane derivative may be represented by following Formula 2.

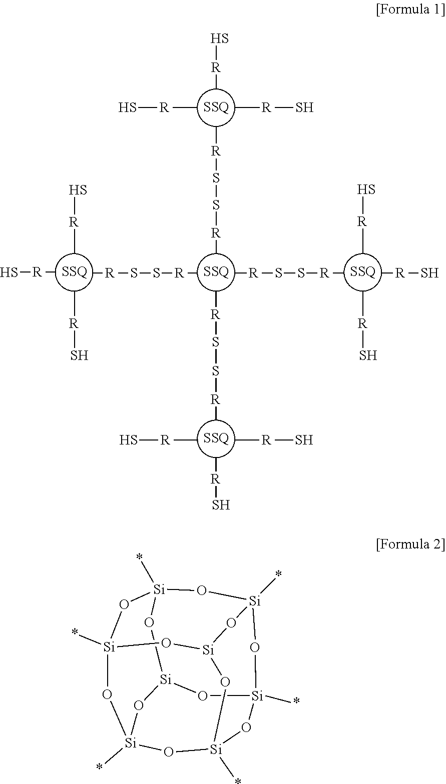

The binder may be a photo-reactive (photo-curable) compound. For example, the binder may be an acrylate compound. Namely, the hard-coating layer 120 includes a binder cured by UV radiation. For example, the binder may be one of polyesteracrylate, epoxyacrylate, urethaneacrylate and siloxane modified acrylate.

In addition, R in Formula 1 may be represented by following Formula 3 or may be an aromatic group. The aromatic group may include benzene and naphthalene. The self-healing reactivity and an absorption wavelength range of the silicon compound may depend on R. Namely, in the hard-coating layer 120 of the present invention, the self-healing operation is generated by absorption of visible light.

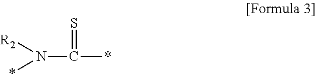

In Formula 3, R₂ may be C1-C20 alkyl.

Since the disulfide group combines adjacent silsesquioxane derivatives, the disulfide group is structurally or spatially shielded by the silsesquioxane derivatives. Accordingly, the disulfide group remains in the hard-coating layer 120, and the hard-coating layer 120 has a self-healing characteristic.

When the disulfide group is not shielded by the silsesquioxane derivative and is structurally or spatially exposed, the disulfide group is attacked by radiation during the optical-curing process of the binder. As a result, there is no disulfide group remaining in the hard-coating layer. Accordingly, even if the compound including the disulfide group is included in the composition of the hard-coating layer, the hard-coating layer does not have the self-healing characteristic.

However, in the present invention, since the silsesquioxane derivatives are connected to either end of the disulfide groups to structurally or spatially shield the disulfide groups, exposure of the disulfide groups to radiation during the optical-curing process is blocked. Accordingly, the disulfide group remains in the hard-coating layer 120 such that the hard-coating layer 120 has the self-healing characteristic.

FIG. 3 is a view illustrating a self-healing mechanism in a hard-coating layer according to the present invention.

Referring to FIG. 3, when the stress is applied to the hard-coating layer 120 (of FIG. 1), the disulfide group in the silicon compound 300 dissociates or is separated such that defects occur in the hard-coating layer 120. Namely, the disulfide group having a relatively low bonding enthalpy dissociates due to an outer stress. If the defect is not healed, the defect continues to grow resulting in damage, e.g., scratch, to the hard-coating layer 120.

However, in the present invention, the disulfide group is re-generated by visible light such that the defect growth due to stress accumulation is prevented. Namely, since the hard-coating layer 120 of the present invention has the self-healing characteristic due to the optical reversible reaction, damage to the hard-coating layer 120 due to stress, e.g., a user's touch, is prevented.

### Synthesis of Silicon Compound

The silicon compound used for the hard-coating layer 120 of the present invention is synthesized as follows.

(1) Hydrochloric acid (0.5˜10 mL), methanol (10˜100 mL) and 3-mercaptopropyl trimethoxysilane (MPTS, 0.5˜30 mL) were put into the rounded-bottom flask and stirred at a temperature of about 60 to 100° C. for about 12 to 60 hours.

(2) The mixture of (1) was cleaned or washed with methanol several times, and unreacted compounds and/or side-products were removed.

(3) The precipitate of (2) was dissolved in tetrahydrofuran (THF, 0.1˜10 mL), and acetronitrile (1˜300 mL).

(4) The solution of (3) was crystallized at a temperature of about 0 to −20° C. for about 24 hours.

(5) The crystals obtained in (4) were washed with acetone and dried in a vacuum oven for more than 12 hours.

(6) The dried crystals obtained in (5) was dispersed in a solvent and heated at a temperature of about 80 to 100° C. to grow the particle.

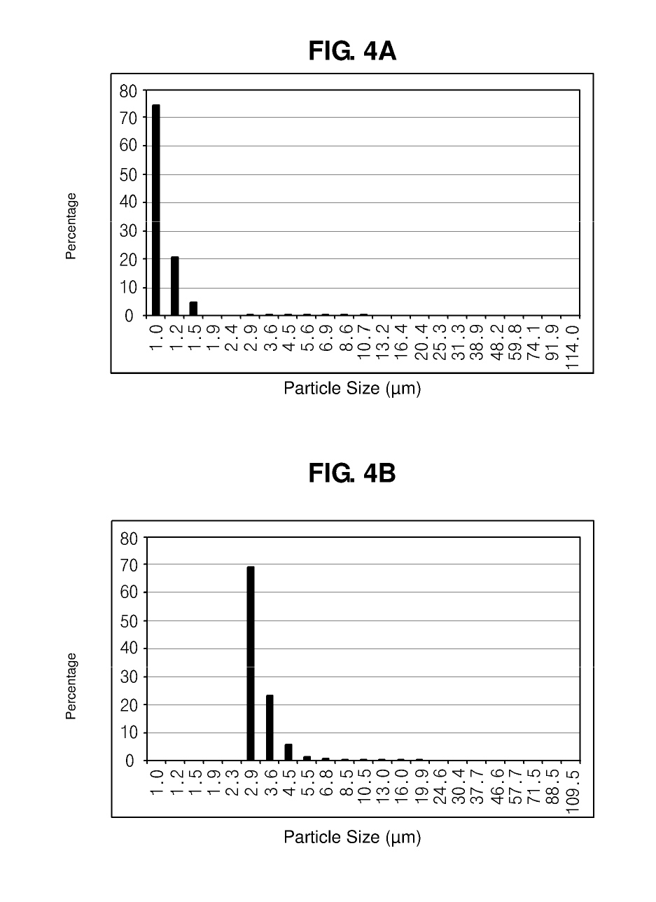

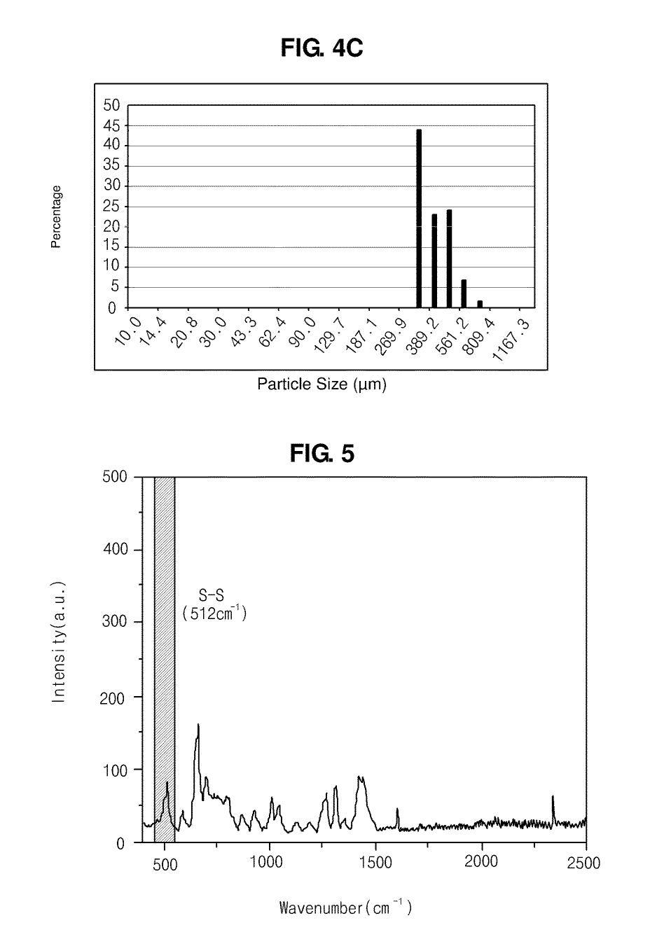

FIGS. 4A to 4C are graphs showing the particle size distributions of a silicon compound.

The graph in FIG. 4A shows a particle size distribution of a silicon compound after step (4), and the graphs in FIGS. 4B and 4C show a particle size distribution of a silicon compound after step (6). The silicon compound particles in FIG. 4B are obtained by heating for about 10 minutes to 1 hour, while the silicon compound particles in FIG. 4C are obtained by heating for about 1 to 8 hours.

As shown in FIGS. 4A to 4C, the particle size of the silicon compound is increased by the heating process of step (6) such that the disulfide groups in the silicon compound are sufficiently shielded by the silsesquioxane derivatives. Namely, when the synthesis of the silicon compound includes the heating process of step (6), the self-healing characteristic of the hard-coating layer 120 is improved.

### Composition of the Hard-Coating Layer

The composition of the hard-coating layer comprises an acrylate-based polymer, an acrylate-based monomer, a photo-initiator, the silicon compound and a solvent. The composition comprises about 100 wt % of the acrylate-based monomer, about 10 wt % of the photo-initiator, about 5 wt % of the silicon compound, and 600 wt % of the solvent, with respect to the acrylate-based polymer. Namely, the composition of the hard-coating layer includes an optical reactive compound (i.e., the acrylate-based polymer and the acrylate-based monomer), the photo-initiator, the silicon compound and the solvent.

For example, the acrylate-based polymer may be one of polyesteracrylate, epoxyacrylate, urethaneacrylate and siloxane modified acrylate; the acrylate-based monomer may be one of pentaerythritol triacrylate (PETA), dipentaerythritol pentacrylate (DPPA), dipentaerythritol hexacrylate (DPHA) and trimethylolpropane triacrylate (TMPTA); the photo-initiator may be Iragacure 184: and the solvent may be one of methylethylketone (MEK), acetone, propyleneglycol, monomethylether and dimethoxyethane, but are not limited thereto.

### Fabrication of the Hard-Coating Layer

The composition comprising 100 wt % of pentaerythritol triacrylate, 10 wt % of Iragacure 184, 5 wt % of the silicon compound and 600 wt % of MEK, with respect to the amount of urethane acrylate, is coated on a base. The coating layer is dried at a temperature of 80° C. for 10 minutes and cured using UV radiation (300˜380 nm) for 10 to 300 seconds to form the hard-coating layer.

FIG. 5 is a Raman spectrograph showing the presence of disulfide groups in the hard-coating layer fabricated using the UV irradiation process.

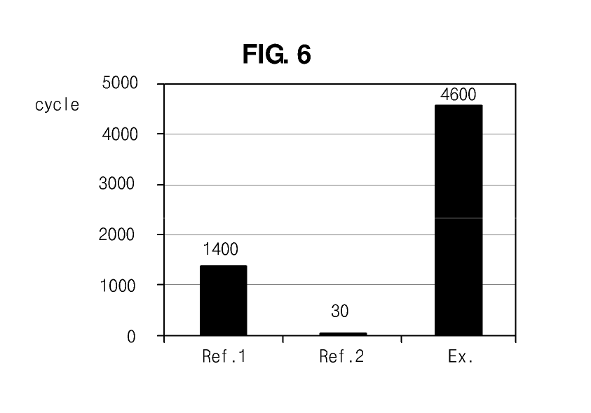

FIG. 6 is a graph showing an anti-scratch characteristic of a hard-coating layer.

In FIG. 6, “Ref. 1” shows the anti-scratch characteristic of a hard-coating layer including a urethane acrylate binder without silsesquioxane derivatives and disulfide groups, “Ref. 2” shows the anti-scratch characteristic of a hard-coating layer including a urethane acrylate binder with silsesquioxane derivatives but without disulfide groups, and “Ex.” shows the anti-scratch characteristic of a hard-coating layer including a urethane acrylate binder with a silicon compound including silsesquioxane derivatives and disulfide groups.

As shown in FIG. 6, in the hard-coating layer including silsesquioxane compound without a disulfide group (“Ref 2”), the anti-scratch characteristic is degraded. However, when the silicon compound including a disulfide group (“Ex”) is added to form the hard-coating layer 120, the anti-scratch characteristic is remarkably improved.

Namely, in the hard-coating layer of “Ref. 1” and “Ref. 2” the defect grows due to stress accumulation such that damages, i.e., scratches, are generated in the hard-coating layer. However, in the hard-coating layer of “Ex.” according to the present invention, because the disulfide group has the self-healing characteristic when exposed to visible light, damage in the hard-coating layer is prevented.

It will be apparent to those skilled in the art that various modifications and variations can be made in the present invention without departing from the spirit or scope of the invention. Thus, it is intended that the present invention covers modifications and variations of this invention provided they are within the scope of the original claims and their equivalents.

What is claimed is:

1. A hard-coating layer, comprising:
a binder; and
a silicon compound dispersed in the binder, wherein the silicon compound comprises a disulfide group, which connects adjacent siloxane groups.

2. The hard-coating layer according to claim 1, wherein the siloxane group is a silsesquioxane derivative.

3. The hard-coating layer according to claim 2, wherein the silicon compound is represented by following Formula 1, wherein SSQ is the silsesquioxane derivative represented by following Formula 2, and wherein R in Formula 1 is an aromatic group or 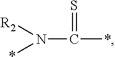
wherein R₂ is a C1-C20 alkyl:

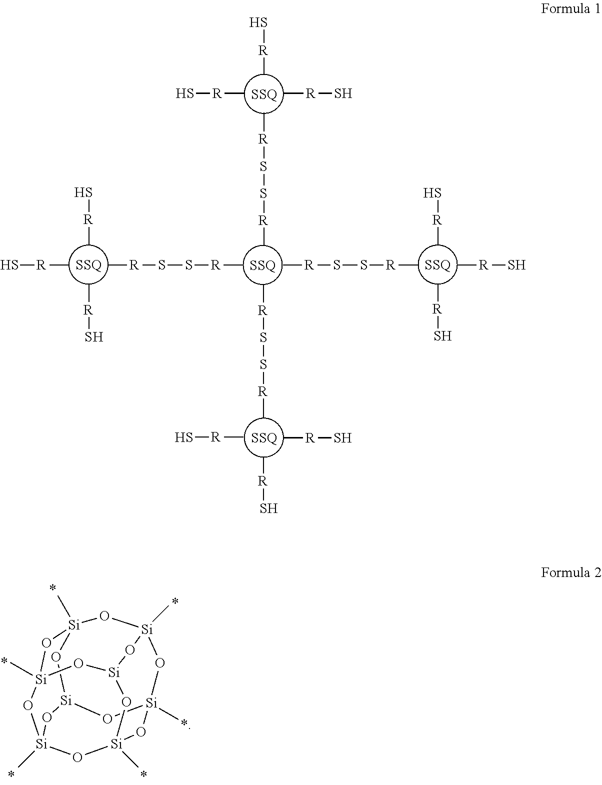

4. A display device, comprising:
a hard-coating layer including a binder and a silicon compound dispersed in the binder, wherein the silicon compound comprises a disulfide group connecting adjacent siloxane groups; and
a display device on a side of the hard-coating layer.

5. The display device according to claim 4, wherein the siloxane group is a silsesquioxane derivative.

6. The display device according to claim 5, wherein the silicon compound is represented by following Formula 1, wherein SSQ is the silsesquioxane derivative represented by following Formula 2 and wherein R in Formula 1 is an aromatic group or 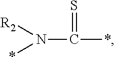
wherein R₂ is a C1-C20 alkyl:

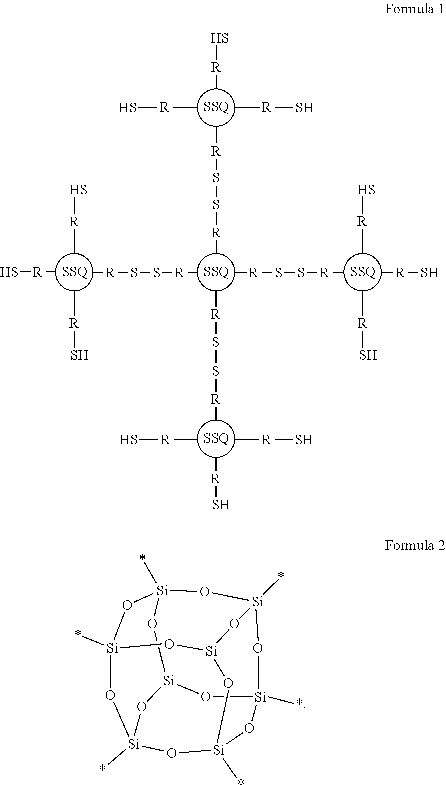

7. The display device according to claim 4, wherein the display panel includes a polarization plate, and the hard-coating layer is in contact with the polarization plate.

8. The display device according to claim 4, further comprising: a touch panel positioned between the hard-coating layer and the display panel.

9. The display device according to claim 4, wherein the hard-coating layer has a self-healing characteristic.

10. A method of fabricating a hard-coating layer, comprising:
coating a mixture including a silicon compound, a photo-reactive compound, a photo-initiator and a solvent on a base, wherein the silicon compound includes a disulfide group connecting adjacent siloxane groups; and
irradiating the coated mixture with UV radiation to form the hard-coating material layer.

11. The method according to claim 10, wherein the siloxane group is a silsesquioxane derivative.

12. The method according to claim 11, wherein the silicon compound is represented by following Formula 1, wherein SSQ is the silsesquioxane derivative represented by following Formula 2, and wherein R in Formula 1 is an aromatic group or 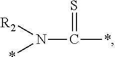
wherein R₂ is a C1-C20 alkyl: [chemical structure]
